(19) United States
(12) Patent Application Publication
(10) Pub. No.: US 2011/0159287 A1
(43) Pub. Date: Jun. 30, 2011

(54) Process for the Production of Ultra High Molecular Weight Polyethylene

(75) Inventors: Nicolaas Hendrika Friederichs, Brunssum (NL); Dieter Hubert Bilda, Aachen (DE); Raymond Gerlofsma, Brunssum (NL)

(73) Assignee: Saudi Basic Industries Corporation, Riyadh (SA)

(21) Appl. No.: 12/937,889

(22) PCT Filed: Apr. 14, 2009
(86) PCT No.: PCT/EP09/02778

§ 371 Date: Feb. 7, 2011

(30) Foreign Application Priority Data
Apr. 17, 2008 (EP) 08075299.1

(51) Int. Cl. C08F 4/646

(52) U.S. Cl. 428/402; 526/123.1

(57) ABSTRACT

The invention relates to a process for the production of ultra high molecular weight polyethylene having a molecular weight between 1000000 g/mol and 10000000 g/mol, an average particle size (D₅₀) in the range between 50 and 250 μm and a bulk density in the range between 100 and 350 kg/m³ in the presence of a catalyst system that comprises

(I) the solid reaction product obtained from the reaction of:

a) a hydrocarbon solution containing

1) an organic oxygen containing magnesium compound or a halogen containing magnesium compound and

2) an organic oxygen containing titanium compound and

b) an organo aluminium halogen compound having the formula AIRₙ X₃₋ₙ in which R is a hydrocarbon radical containing 1-10 carbon atoms X is halogen and 0<n<3 and

(II) an aluminium compound having the formula AIR₃ in which R is a hydrocarbon radical containing 1-10 carbon atom.

The present invention relates to a process for the production of ultra high molecular weight polyethylene in the presence of a specific catalyst system.

The catalytic production of polyethylene is very well known in the art. A very special class of polyethylene is ultra high molecular weight polyethylene (UHMWPE) with a very high average molecular weight ranging from about 1000000 to well above 6000000 grams/mole whereas high density polyethylene (HDPE) typically has a molar mass between about 50000 and 300000 g/mol. Therefore, these linear polymers have an average molecular weight much higher than that of linear high density polyethylene. The polymer synthesis to obtain UHMWPE is disclosed in Journal of Macromolecular Science Part C Polymer Reviews, Vol. C42, No 3, pp 355-371, 2002. The higher molecular weight gives UHMWPE the unique combination of characteristics making it suitable for applications where lower molecular weight grades fail. The very high molecular weight of this polyethylene results in excellent properties for example a very high abrasion resistance, a very high impact resistance, a very high melt viscosity and a low dynamic coefficient of friction. Because of the high molecular weight and the high melt viscosity specialized processing methods like compression moulding and ram extrusion are applied. Since ultra high molecular weight polyethylene has a high molecular weight and a bad flowability when molten, it is difficult to mould it into a pellet form and the product has to be delivered in a powder form and even more important, it has also to be processed from powder. Consequently, the powder properties heavily determine the production process as well as the converting process. For certain applications, the ultra high molecular weight polyethylene powder has to be filled with additives, which have to be distributed homogeneously in the melt of the polymer. For this application, the use of polymer powder having an irregular structure is desired. In addition, for applications of UHMWPE, where the finished product should have porosity, also an irregular structure of the powder is desired as described by H. L. Stein in Engineered Materials Handbook, Volume 2: Engineering Plastics, ASM International 1999 page 167-171. Such an irregular structure of the unfilled powder requires a bulk density of the polymer powder lower then about 350 kg/m³.

Preferably the average particle size (D₅₀) of the polymer is lower than 250 μm and more preferably below 200 μm.

Furthermore powder particles having an irregular structure should have a particle size distribution, commonly known as the “span”, (D₉₀-D₁₀)/D₅₀) above 1.

The shape of the polymer powder particles is translated from the shape of the catalyst particles, also known as the replica phenomenon. In general, when this replication takes place, the average particle size of the polymer is proportional to the cube root of the catalyst yield, i.e. the grams of polymer produced per gram of catalyst. (See for example Dall'Occo et al, in “Transition Metals and Organometallics as Catalysts for Olefin Polymerization” Kaminsky , Sinn and Eds. Springer, 1988, page 209-222). Due to this proportionality, one could produce small polymer particles by reducing the catalyst yield, but this causes high catalyst residues in the polymer and also high catalyst costs needed to produce the polymer. This puts severe requirements on the catalyst because a high catalyst activity combined with a polymer particle size below 250 μm, preferably below 200 μm is required.

It is the object of the present invention to provide an economical process for preparing UHMWPE having an irregular particle structure and an average polymer particle size below 250 μm.

The object is achieved by a process for the production of ultra high molecular weight polyethylene having a molecular weight between 1000000 g/mol and 10000000 g/mol, an average particle size (D₅₀) in the range between 50 and 250 μm and a bulk density in the range between 100 and 350 kg/m³ in the presence of a catalyst system that comprises

(I) the solid reaction product obtained from the reaction of:
a) a hydrocarbon solution containing
   1) an organic oxygen containing magnesium compound or a halogen containing magnesium compound and
   2) an organic oxygen containing titanium compound and
b) an aluminium halogenide having the formula AIRₙX₃₋ₙ in which R is a hydrocarbon radical containing 1-10 carbon atoms X is halogen and 0<n<3 and

(II) an aluminium compound having the formula AIR₃ in which R is a hydrocarbon radical containing 1-10 carbon atom.

The alumium compound (II) is dosed prior to or during the polymerization and may be referred to as a cocatalyst.

The span of the obtained powder particles is above 1.5.

An advantage of the use of the catalyst is the very high catalyst activity. Because the productivity of the catalyst is high the catalyst residues in the polymer are very low.

Another advantage of the use of the catalyst is that the synthesis to produce the catalyst is relatively simple and cheap based on readily available and relatively easy to handle compounds.

Suitable organic oxygen containing magnesium compounds include for example alkoxides such as magnesium methylate, magnesium ethylate and magnesium isopropylate and alkylalkoxides such as magnesium ethylethylate.

According to a preferred embodiment of the invention the organic oxygen containing magnesium compound is a magnesium alkoxide

Preferably the magnesium alkoxide is magnesium ethoxide Mg(OC₂H₅)₂.

Suitable halogen containing magnesium compounds include for example magnesium dihalides and magnesium dihalide complexes wherein the halide is preferably chlorine.

Preferably the hydrocarbon solution comprises an organic oxygen containing magnesium compound as (I) (a) (1).

Suitable organic oxygen containing titanium compound may be represented by the general formula [TiOₓ (OR)_{4-2x]n} in which R represents an organic radical, x ranges between 0 and 1 and n ranges between 1 and 6.

Suitable examples of organic oxygen containing titanium compounds include alkoxides, phenoxides, oxyalkoxides, condensed alkoxides, carboxylates and enolates.

According to a preferred embodiment of the invention the organic oxygen containing titanium compounds is a titanium alkoxide.

Suitable alkoxides include for example Ti (OC₂H₅)₄, Ti (OC₃H₇)₄, TiOC₄H₉)₄ and Ti(OC₈H₁₇)₄.

According to a preferred embodiment of the invention the organic oxygen containing titanium compound is Ti (OC₄H₉)₄.

Preferably the aluminium halogenide is a compound having the formula AIR, X₃₋ₙ in which R is a hydrocarbon radical containing 1-10 carbon atoms, X is halogen and 1.5<n<3.

Suitable examples of the aluminium halogenide in (I) b having the formula AIRₙX₃₋ₙ include aluminium tri chloride, ethyl aluminium dibromide, ethyl aluminium dichloride, propyl aluminium dichloride, n-butyl aluminium dichloride, iso butyl aluminium dichloride, diethyl aluminium chloride, diisobutyl aluminium chloride, triisobutyl aluminium and tri-n-hexyl aluminium. Preferably X is Cl.

According to a preferred embodiment of the invention the organo aluminium halogenide in (I) b) is an organo aluminium chloride, more preferably ethyl aluminium dichloride.

Suitable examples of the cocatalyst of the formula AIR₃ include tri ethyl aluminium, tri isobutyl aluminium, tri-n-hexyl aluminium and tri octyl aluminium. Preferably the aluminum compound in (II) of the formula AIR₃ is tri ethylaluminium or tri isobutyl aluminium.

The hydrocarbon solution of organic oxygen containing magnesium compound and organic oxygen containing titanium compound can be prepared according to procedures as disclosed for example in U.S. Pat. No. 4,178,300 and EP0876318. The solutions are in general clear liquids. In case there are any solid particles, these can be removed via filtration prior to the use of the solution in the catalyst synthesis.

According to a preferred embodiment of the invention the molar ratio of aluminium from (b): titanium from (a) is higher then 3:1.

Preferably this ratio is higher than 5:1

In a preferred embodiment of the invention the molar ratio of magnesium: titanium is lower than 3:1.

Preferably the molar ratio magnesium: titanium ranges between 0, 2:1 and 3:1.

According to a preferred embodiment of the invention the molar ratio of aluminium from (II): titanium from (a) ranges between 1:1 and 300:1

More preferably the molar ratio of aluminium from (II): titanium from (a) ranges between 3:1 and 100:1.

Generally the average particle size of the catalyst ranges between 3 μm and 30 μm.

Preferably the average particle size of the catalyst ranges between 3 μm and 10 μm.

Generally the span of the particle size distribution of the catalyst is higher than 0.8.

The catalyst of the present invention may be obtained for example by a first reaction between a magnesium alkoxide and a titanium alkoxide, followed by dilution with a hydrocarbon solvent, resulting in a soluble complex consisting of a magnesium alkoxide and a titanium alkoxide and thereafter a reaction between a hydrocarbon solution of said complex and the organo aluminium halogenide having the formula AIRₙX₃₋ₙ.

Preferably, the aluminium halogenide having the formula AIRₙX₃₋ₙ is used as a solution in a hydrocarbon. Any hydrocarbon that does not react with the organo aluminium halogenide is suitable to be applied as the hydrocarbon.

The sequence of the addition can be either adding the hydrocarbon solution containing the organic oxygen containing magnesium compound and organic oxygen containing titanium compound to the compound having the formula AIRₙX₃₋ₙ or the reversed.

The temperature for this reaction can be any temperature below the boiling point of the used hydrocarbon. Generally the duration of the addition is preferably shorter than 1 hour.

In the reaction of the hydrocarbon solution of the organic oxygen containing magnesium compound and the organic oxygen containing titanium compound with the organo aluminium halogenide of formula AIRₙX₃₋ₙ, a solid precipitates. After the precipitation reaction the resulting mixture is heated for a certain period of time to finish the reaction. After the reaction the precipitate is filtered and washed with a hydrocarbon. Other means of separation of the solids from the diluents and subsequent washings can also be applied, like for example multiple decantation steps. All steps should be performed in an inert atmosphere of nitrogen or another suitable inert gas.

The polymerization reaction may be performed in the gas phase or in bulk in the absence of an organic solvent, or carried out in liquid slurry in the presence of an organic diluent. The polymerization can be carried out batchwise or in a continuous mode. These reactions are performed in the absence of oxygen, water, or any other compounds that may act as a catalyst poison. Suitable solvents include for example alkanes and cycloalkanes for example pentane, hexane, heptane, n-octane, iso-octane, cyclohexane, and methylcyclohexane; alkylaromatics such as toluene, xylene, ethylbenzene, isopropylbenzene, ethyltoluene, n-propylbenzene and diethyl benzene. The polymerization temperature may range between 20° C. and 200° C. and is preferably lower than 120° C. The pressure of a monomer during polymerization is adequately the atmospheric pressure and more preferably 2-40 bars. (1bar=100000 Pa)

The polymerization can be carried out in the presence of so-called anti-static agent or anti fouling agent, in an amount ranging from 1 to 500 ppm related to the total reactor contents.

As is well known in the art, so-called external donors may be applied during the polymerization in order to further modify the catalyst performance if this is desired. Suitable external donors are organic compounds containing hetero atoms which have at least one lone pair of electrons available for coordination to the catalyst components or aluminum alkyls. Suitable examples of external donors include alcohols, ethers, esters, silanes and amines.

The molecular mass of the polymer may be controlled by any means as known in the art, for example by adjustment of the polymerization temperature or by the addition of molecular weight control agents for example hydrogen or diethyl zinc.

Due to the very high molecular weight of UHMWPE, it is difficult to analyze its molar mass by for instance Gel Permeation Chromatography (GPC). Also the application of methods based on melt-viscosity is not straightforward.

For instance, at molecular weights above 1000000 g/mol, the determination of the melt-index according to ASTM D-1238 becomes difficult.

Even at high loadings of 21.6 kg, the melt index of UHMWPE drops to values below 0.1 dg/min, even below 0.02 dg/min. Berzen et al. disclose at page 281 in The British Polymer Journal, Vol. 10, December 1978 that with ultrahigh molecular weight polyethylene the melt flow cannot be determined as a stationary flow does not occur.

A more suitable technique is based on the so called Flow Value. The Flow Value can be determined according to DIN 53493. This Flow Value can subsequently be translated into the molecular weight as disclosed for example by J. Berzen et al. in The British Polymer Journal, Vol. 10, December 1978, pp 281-287.

UHMWPE can be applied in very different areas where excellent impact strength and abrasive wear resistance are required. In medical applications UHMWPE is for example used in knee, shoulder and hip implants, high strength fibres made from UHMWPE can be found in ballistic cloth, fishing lines and nets and in the mining industry, UHMWPE can also be used as hopper or bunker liners. According to a preferred embodiment of the invention the polyethylene powder is used in dust collection filters and water purification filters.

U.S. Pat. No. 6,204,349 is directed to a pipe made of a linear polyethylene having characteristics different from UHMWPE. Ultra high weight polymers could be obtained in the case that the cocatalyst is diethyl aluminium mono chloride. EP 523785 and EP 350339 disclose solid catalyst components based on titanium and magnesium which are used in the preparation of polyethylene. However these publications are not directed to UHMWPE because the obtained polyethylene displays values for the melt index. Also U.S. Pat. No. 7,160,453 does not relate to UHMWPE because of the specified flow index value. As indicated in the foregoing with ultrahigh molecular weight polyethylene the melt flow cannot be determined.

The invention will be elucidated by means of the following non-restrictive examples.

### EXAMPLES

The poured bulk density of the ultra high molecular weight polyethylene polymer powder is determined by measuring the bulk density of the polymer powder according to the procedure outlined in ASTM D1895/A. The Flow Value is determined according to DIN53493. The average particle size (D₅₀) of the catalyst was determined by the so called laser light scattering method in hexanes diluent using a Malvern Mastersizer equipment. The average particle size and particle size distribution (“span”) of the polymer powders were determined by sieve analyses according to DIN53477.

### Example I

Preparation of a hydrocarbon solution comprising an organic oxygen containing magnesium compound and an organic oxygen containing titanium compound

100 grams of granular Mg(OC₂H₅)₂ and 150 millilitres of Ti(OC₄H₉)₄ were brought in a 2 litre round bottomed flask equipped with a reflux condensor and stirrer. While gently stirring, the mixture was heated to 180° C. and subsequently stirred for 1.5 hours. During this, a clear liquid was obtained. The mixture was cooled down to 120° C. and subsequently diluted with 1480 ml of hexane. Upon addition of the hexane, the mixture cooled further down to 67° C. The mixture was kept at this temperature for 2 hours and subsequently cooled down to room temperature. The resulting clear solution was stored under nitrogen atmosphere and was used as obtained. Analyses on the solution showed a titanium concentration of 0.25 mol/l.

### Example II

Preparation of the Catalyst

In a 0.8 liters glass reactor, equipped with baffles, reflux condenser and stirrer, 350 ml hexanes and 170 ml of the complex from Example I was dosed. The stirrer was set at 1200 RPM. Via a peristaltic pump, 91 ml of 50% ethyl alumimium dichloride (EADC) solution were dosed in 30 minutes time. Subsequently, the mixture was refluxed for 2 hours. After cooling down to ambient temperature, the obtained red/brown suspension was transferred to a glass filter and the solids were separated. The solids were washed 3 times with 500 ml of hexanes. Finally, the solids were taken up in 500 ml of hexanes and the resulting slurry was stored under nitrogen.

### Example III

Polymerization

The polymerization was carried out in a 10 litres autoclave using 5 litres purified hexanes as a diluent. 4 mmols of tri-isobutylaluminum were added to the 5 litres purified hexanes. The mixture was heated to 75° C. and pressurized with 0, 5 bars ethylene. Subsequently a slurry containing 40 mg of the catalyst obtained in Example II was dosed. The temperature was maintained at 75° C. and the pressure was kept constant by feeding ethylene. The reaction was stopped after 150 minutes. Stopping was performed by de-pressurizing and cooling down the reactor. The reactor contents were passed through a filter; the wet polymer powder was collected and subsequently dried. An amount of 494 grams of UHMWPE powder was produced. The polymer powder had the following characteristics

a bulk density of 260 kg/m³

an average particle size of 83 μm and

a Flow Value of 0,227 N/mm²,

### Example IV

Polymerization

The polymerization was carried out similarly to the procedure as described in Example III, with the exceptions that the polymerization was stopped after 120 minutes and 4 mmols of tri-n-octylaiuminum were used instead of tri-isobutylaluminum. In this example 497 grams of UHMWPE powder were produced.

The polymer powder had the following characteristics:

a bulk density of 250 kg/m³

an average particle size of 84 μm and

a Flow Value of 0,261 N/mm².

### Example V

Preparation of the catalyst

A catalyst was prepared according to Example II, with the difference that EADC was dosed in 15 minutes.

### Example VI

Polymerization

The polymerization was carried out according to Example III, with the exceptions that the catalyst according to Example V was applied and the polymerization was stopped after 120 minutes.

In this example 397 grams of UHMWPE were produced. The polymer powder had the following characteristics:

a bulk density of 190 kg/m³

an average particle size of 120 μm and

a Flow value of 0,203 N/mm²

1. A process for the production of ultra high molecular weight polyethylene having a molecular weight between 1000000 g/mol and 10000000 g/mol, an average particle size (D₅₀) in the range between 50 and 250 μm and a bulk density in the range between 100 and 350 kg/m³ in the presence of a catalyst system comprising:
(I) the solid reaction product obtained from the reaction of
a) a hydrocarbon solution containing
1) an organic oxygen containing magnesium compound or a halogen containing magnesium compound and
2) an organic oxygen containing titanium compound and
b) an aluminium halogenide having the formula AIRₙX₃₋ₙ in which R is a hydrocarbon radical containing 1-10 carbon atoms, X is halogen and 0<n<3 and
(II) an aluminium compound having the formula AIR₃ in which R is a hydrocarbon radical containing 1-10 carbon atom.

2. The process according to claim 1 characterised in that the organic oxygen containing magnesium compound is magnesium alkoxide.

3. A The process according to claim 2 characterised in that the magnesium alkoxide is magnesium ethoxide.

4. The process according to claim 1 wherein the organic oxygen containing titanium compound is titanium alkoxide.

5. The process according to claim 4 wherein the titanium alkoxide is Ti(OC₄H₉)₄.

6. The process according to claim 1 wherein the aluminium halogenide (I) b) is alkyl aluminium chloride.

7. The process according to claim 1 wherein the aluminium compound (II) is triethylaluminium or triisobutyl aluminium.

8. The process according claim wherein the molar ratio of aluminium from (I) (b): titanium from (I) (a) is higher then 3:1.

9. The process according to claim 1 wherein the molar ratio of magnesium: titanium is lower than 3:1.

10. A dust collection filter or water purification filter comprising an ultra high molecular weight polyethylene powder having:
a) molecular weight between 1,000,000 g/mol and 10,000,000 g/mol
b) _{D}₅₀ in the range between 50 and 250 μm and
c) bulk density in the range between 100 and 350 kg/m³.
